(19) United States
(12) Patent Application Publication
(10) Pub. No.: US 2017/0270246 A1
(43) Pub. Date: Sep. 21, 2017

(54) METHOD AND SYSTEM FOR CALCULATION AND GRAPHICAL PRESENTATION OF DRUG-DRUG OR DRUG-BIOLOGICAL PROCESS INTERACTIONS ON A SMART PHONE, TABLET OR COMPUTER

(71) Applicant: Andrius Baskys, Newport Beach, CA (US)

(72) Inventor: Andrius Baskys, Newport Beach, CA (US)

(21) Appl. No.: 15/465,404

(22) Filed: Mar. 21, 2017

Related U.S. Application Data
(60) Provisional application No. 62/310,813, filed on Mar. 21, 2016.

(51) Int. Cl. G06F 19/26; G06F 19/18; G06F 19/28

(52) U.S. Cl. CPC G06F 19/26; G06F 19/28; G06F 19/18

(57) ABSTRACT

A method and system is provided for visualization and pictorial presentation to a user of possible interactions between a prospective drug that is being considered for prescribing to a person and that person's genotype. Genetic information of the person that can affect the manner in which a drug acts on a molecular, physiological or biological function of the body or a tissue, or a manner in which a drug is being metabolized, absorbed, excreted or otherwise eliminated from the body or a tissue by the body or tissue systems, is entered into a computerized device. The computerized device conducts a search of a drug database for drugs that have known interactions with the entered genetic information, and assigns a numeric value to each of a plurality of drugs, either in aggregate, as a class, or individually, in order to quantify the nature, strength and direction of each interaction. The computer sends the assigned numeric values to the computer's output module for their visual presentation to a user as a graph including a panel of columns, or other geometrical structures, whose geometrical characteristics correspond to the assigned numeric values of each drug, in order to facilitate the prospective drug selection by a prescriber on the basis of the totality of drug-gene and/or drug-drug interactions presented to the user as a visual graph.

### CROSS-REFERENCE TO RELATED PATENT APPLICATION

This patent application claims benefit under 35 U.S.C. §119 to U.S. provisional patent application Ser. No. 62/310,813 filed on Mar. 21, 2016, entitled “A Tool For Calculation And Graphical Presentation Of Drug-Drug Or Drug-Biological Process Interactions On A Smart Phone, Tablet Or Computer,” which is incorporated herein by reference in its entirety as part of the present disclosure.

### FIELD OF THE INVENTION

The present invention relates to methods and systems of pharmacogenomic data analysis and visualization for the purpose of medication selection for prescribing by the user. More specifically, it provides pharmacogenetic, drug-drug and drug-gene interaction impact visualization on the basis of available genetic information of a patient and information about other medications or foods/nutrition supplements that the patient of the system may be taking.

### BACKGROUND INFORMATION

Despite the improved side effect profiles of pharmacological agents (also referred to as medications, prescription drugs, etc.), many patients experience significant side effects, symptom relapse, lack of treatment response or undesirable drug-drug interactions [Antai-Otong et al., 2003, Iuppa et al., 2913, Hemke and Shams, 2013, Givens et al., 2016]. In the U.S. there is an incidence of adverse effects of 6.2-6.7% of hospitalized patients, representing two million adverse drug reactions per year [Pirmohamed et al., 2004]. Of these, 0.15 to 0.3% are fatal, leading to about 100,000 deaths annually [Evans et al., 2004]. In Europe, the data are similar While many drugs are often prescribed based on the assumption that all patients respond to a drug in an identical or at least in a similar way, drug pharmacokinetic properties including absorption, distribution, metabolism and excretion vary markedly between individuals [Hemke and Shams, 2013]. Numerous genetic variants including single nucleotide polymorphisms (SNPs), insertions/deletions (Indels), copy number variations (CNVs) etc., have now been identified that influence not only the drug metabolism but also its efficacy by altering properties of the drug target, often referred to as a receptor, as well as other aspects of drug actions [World Guide in Pharmacogenomics, Cacabelos 2012].

Recent advances in molecular genetics offer greatly increased understanding of the relationship between genetic variations, drug effectiveness and their side effects. This approach is often referred to as pharmacogenetics and pharmacogenomics and is in part revealed by pharmacogenetic testing (PGx). PGx technology has recently become commercially available for physicians and non-physician prescribers who wish to prescribe or use medications with a consideration of the patient's genotype information.

Use of an individual patient's DNA data for prescribing medications offers enormous potential for improving treatment outcomes and reducing health care costs. For example, testing a patient for variations in genes associated with deficient drug metabolism before prescribing a drug could identify those drugs that are likely to cause more side effects or elicit greater therapeutic responses in that patient [Baskys, 2015]. Accordingly, FDA labeling information has now been modified to include dosing recommendations based on metabolyzer phenotype. For example, an aripiprazole (Abilify) label includes the following statement: “Dosing recommendation in patients who are classified as CYP2D6 poor metabolizers (PM): The aripiprazole dose in PM patients should initially be reduced to one-half (50%) of the usual dose and then adjusted to achieve a favorable clinical response” and “Laboratory tests are available to identify CYP2D6 PMs”. Similarly, a citalopram (Celexa) label states that “Celexa 20 mg/day is the maximum recommended dose administered to CYP2C19 poor metabolizers due to the risk of QT prolongation.” The FDA “Table of Pharmacogenomic Biomarkers in Drug Labeling” lists over 200 drugs of which 30 are CNS drugs with recommendations for genetic testing in their product labels [Table of Pharmacogenomic Biomarkers in Drug Labeling.http://www.fda.gov/Drugs/ScienceResearch/ResearchAreas/Pharmacogenetics/ucm03378.htm. Last accessed Feb. 3, 2017].

However, implementation of the PGx into clinical practice has been slow and acceptance of pharmacogenetic testing by prescribers has been wavering [Patel et al, 2014, Hess et al, 2015, Peterson et al 2017]. To understand the reasons of prescriber reluctance, it is important to recognize that a distinguishing feature of PGx testing is production of a comparatively large number of data points. Most commercially produced PGx testing reports available today include data on approximately 15 to 130 pharmacogenes. While these numbers are miniscule compared, for example, to data sets produced by whole exome or whole genome sequencing, they are nearly impossible for a human mind to meaningfully integrate into a clinical decision during a short patient visit, typically ranging from 7 to 15 minutes depending on the specialty. For example, a study found that a clinical pharmacist on average spends 76.6 minutes with patients communicating PGx results [Ferreri et al, 2014)].

Furthermore, PGx generated data sets become more complex when interactions with a patient's medications or nutritional supplements are taken into consideration. Software tools designed for research data analysis are usually geared towards revealing statistical relationships, which is exactly opposite to the clinical setting aiming to address an individual's problems and cannot be successfully used on a routine basis in a clinic environment. Other existing software tools designed to analyze PGx data often require to enter personally identifiable patient information, potentially opening a possibility for privacy violations or drastically reducing system robustness due to multiple sign-ons.

Currently, a typical commercial laboratory PGx report is a complex multi-page tabular format-based document that may contain a list of hypothetical drugs or supplements that are ranked on a three-level scale that may be color-coded (green-acceptable, yellow-use with caution, red-do not use) to correspond to drug actions in the presence of Extensive, Intermediate, Poor and Ultrarapid metabolizer (EM, IM, PM and UM respectively) phenotypes of cytochrome P450 peroxidase enzymes (CYP) responsible for the drug metabolism and elimination. Thus, the Extensive metabolizer or EM phenotype is often referred to as a “normal” phenotype. EMs carry two functional CYP gene alleles that encode fully functional corresponding CYP enzymes mediating drug biotransformation. The FDA does not recommend dose adjustments for EMs, however some studies show somewhat weaker drug effects compared to IMs or PMs.

The Intermediate metabolizer or IM phenotype arises from one functional and one non-functional allele, and in most instances show normal metabolic activity not unlike the EM. However, if a person who is an EM or IM, the latter being a carrier of a partially compromised enzyme, metabolic pathway or other biological process, is prescribed a drug that is an inhibitor of the corresponding CYP enzyme, that person can become a Poor metabolizer (see below), a phenomenon called phenoconversion. Clinically this may present as a sudden appearance of side effects associated with a drug that a patient had been taking without problems for some time upon addition of an another drug to the patient's medication regimen. The clinical significance of this phenomenon is reflected in the US Food and Drug Administration (FDA) warnings and in some manufacturers' package inserts. For example, the FDA warns that fluoxetine (other examples are quinidine, paroxetine) inhibits the activity of CYP2D6 and may make individuals with normal CYP2D6 metabolic activity resemble a poor metabolizers. The Poor metabolizers or PMs are individuals who have two non-functional alleles. One example of such genotype could be an individual who has a deletion of CYP2D6 gene. If prescribed a medication that is metabolized by the affected CYP2D6 enzyme, a PM will likely have unexpectedly higher drug concentration, which could result in drug toxicity. However, unlike the condition of EMs and particularly IMs, a drug that is an inhibitor of the affected enzyme will have a negligible to no impact on the plasma drug concentration of the inhibitor drug. Ultrarapid metabolizers or UMs have either a duplication of a CYP gene or carry a variant allele that increases the rate of drug metabolism by the encoded enzyme. If such an individual is taking a medication that is metabolized by that enzyme they will have a low drug plasma concentration, which in could make the drug ineffective at regular dosages.

It is evident that the significance of these definitions (EM, IM, PM and UM) depend on the clinical context, in particular, on the medications that the patient is already taking as well as on the medications that are being considered to be prescribed to the patient. However, since it is not possible to know apriori which medications will the patient be prescribed in a course of his or her lifetime, the 3-level PGx reports may not be directly related to the ongoing treatment issues and therefore may only be of a very limited clinical utility. Importantly, these reports do not take into account interactions between the medications that the patient may already be taking as well as those that are yet to be prescribed, and the pertinent biological pathways compromised by genetic mutations. In addition, reading and understanding tabular PGx reports could be prohibitively time-consuming and may require special training in genetics that most prescribers do not have. PGx results ordered by one provider (e.g. a psychiatrist, who is primarily concerned with an antidepressant or antipsychotic medication) typically do not contain information that could be of significance to another provider (e.g. an internist who prescribes cholesterol lowering or blood pressure lowering drugs). Significantly, suitable tools for practitioner education on DNA data application in clinical practice are critically lacking.

It is therefore evident that there is a niche for a simple bioinformatics tool that could present pertinent drug-genotype and drug-drug interaction information in an easy to comprehend format, that could be easy to use for someone without a special training, that could be sufficiently robust to be employed during a short prescriber-patient encounter and produce information pertinent to a specific patient without jeopardizing patient privacy, and/or that could be transferable from one clinical setting to another, or used by the patient when selecting over the counter drugs or nutraceuticals.

### SUMMARY OF THE INVENTION

In accordance with one aspect, the present invention is directed to method of visualization and pictorial presentation to a user of possible interactions between a prospective drug that is being considered for prescribing to a patient and that patient's genotype. The method comprises the following steps: Entering the patient's genetic information into a computing device. The entered genetic information may be the patient's genetic data reflecting distinct pharmacogenetic phenotypes of cytochrome oxydase P450 (CYP) genes coding for the corresponding CYP enzymes and termed as poor, intermediate, extensive, and ultrarapid metabolizers, DNA variation data that may include single nucleotide polymorphisms (SNPs), copy number variations (CNVs), insertions/deletions (indels) or other variations appearing anywhere in the patient's DNA, DNA methylation, acetylation or any other data of up- or down-regulation of gene expression that affects the manner in which a drug acts on any molecular, physiological or biological function of the body or a tissue, or a manner in which a drug is being metabolized, absorbed, excreted or otherwise eliminated from the body or a tissue by the body or tissue systems.

The data entry causes a computer to, or a user causes the computer after entry of the data, to conduct a search of a comprehensive drug database for drugs that have known interactions with the entered genetic variations, and assign a numeric value to each drug, either in aggregate, as a class, or individually, in order to quantify the nature, strength and direction of each interaction (e.g., a CYP enzyme substrate, an enzyme inhibitor, an inducer, a receptor agonist, an antagonist, etc.). The computer's processor sends the assigned numeric values to the computer's output module for their visual presentation to a user as a graph. In some embodiments of the invention, the graph comprises a panel of columns, or any other geometrical structures, whose height (or size or shape, if the outputted graph is not a column graph) corresponds to the assigned numeric values of each drug. The graph can be subsequently further adjusted according to the numeric values assigned to a separately entered list of drugs that represents drugs that the patient is currently taking, which are also known to interact with the patient's genotype, with the goal of facilitating the prospective drug selection by a prescriber on the basis of the totality of drug-gene and drug-drug interactions presented to the user as a visual graph with column heights or a size of any other geometrical form, such as a circle, reflecting the degree of the interaction on any individual prospective drug that is being considered for prescribing.

In some embodiments, the method further comprises receiving in a computer system a list of drugs, that could include any drug that the patient may be currently taking or may be considering taking in the future, and observing effects of these drugs on genotype-dependent changes in drug biological functions. Such functions may include but are not limited to inflammation, carcinogenesis, electric conductance, including cardiac electric conductance, such as the QT interval and variations thereof, aging, neurodegeneration, growth, tissue differentiation, secretion, reproduction and other similar biological functions.

In some embodiments, the method further comprises receiving in a computer system genetic data where such data are RNA-seq data.

In some embodiments, the method further comprises receiving in a computer system genetic data where such data are methylome data.

In some embodiments, the method further comprises receiving in a computer system genetic data where such data are proteomics data.

In some embodiments, the method further comprises receiving in a computer system genetic data where such data are transcription data.

In some embodiments, the method further comprises receiving in a computer system genetic data where such data are derived from human studies.

In some embodiments, the method further comprises receiving in a computer system genetic data where such data are derived from non-human studies.

In some embodiments, the computer performing calculations and data presentation may be a tablet, a smart phone, a laptop or a desktop, or any other computing device that has graphic output capabilities.

In some embodiments, the user may be also a patient whose genetic and drug interaction data are being analyzed and visually represented.

In some embodiments, the method further comprises receiving in a computer system a list of drugs, that could include any drug that the patient may be currently taking or may be considering taking in the future, and observing effects of these drugs on the graphical depiction of the drug-genotype interactions, and subsequently varying and re-entering the prospective drug candidates in order to obtain a most desirable level of drug interactions as is reflected in the drug-genotype interactions graph.

### BRIEF DESCRIPTION OF THE DRAWINGS

FIGS. 1A, 1B and 1C are a comparison of calculated metabolic rates of a drug “D” (pink columns) by CYP3A4 enzyme coded by the CYP3A4 gene that has no loss-of-function mutations (Extensive metabolizer, FIG. 1A). The Y axis represents drug metabolism inhibition, where “0” corresponds to no inhibition and “1.0” corresponds to 100% inhibition (blue column). In the absence of CYP3A4 gene loss-of-function mutations (Extensive Metabolizer phenotype) there is only a negligible (approximately 5%) inhibition of drug “D” metabolism attributed to this drug being a CYP3A4 enzyme substrate that is tying up the enzymatic reaction by its own metabolism.

FIG. 1B shows inhibition of drug “D” metabolism when there is a loss-of-function mutation in one of the two CYP3A4 alleles (Intermediate Metabolizer phenotype). Note an inhibition of drug “D” metabolism by an approximately 20% due to a reduced metabolizing capacity of the defective CYP3A4 enzyme.

FIG. 1C shows drug “D” metabolism when there is a loss-of-function mutation in one CYP3A4 allele (“Intermediate Metabolizer” phenotype) and in the presence of drug “K”, which is a potent inhibitor of CYP3A4 enzyme. Note an inhibition of drug “D” metabolism by approximately 90% due to a markedly reduced metabolizing capacity of the partially defective CYP3A4 enzyme whose function become suppressed by drug “K”.

FIGS. 2A, 2B and 2C are a visual graphical presentation of drug—genotype effects in the presence of one loss-of-function mutation in the CYP2B6 and the CYP2C9 genes (Intermediate metabolizer phenotype). Actions of two drugs that interact with these enzymes (clopidogrel and cimetidine) and one nutrient (grapefruit juice) are also taken into consideration. Note a high degree of variability in calculated prospective medication metabolic rates for all drugs that have been grouped by drug class (FIG. 2A, antipsychotic medications, FIG. 2B, antidepressant medications and FIG. 2C, anxiolytic-hypnotic medications). Since metabolic rates are known to inversely correlate with the likelihood of drug-induced side effects, selecting a prospective drug for prescribing for this particular patient can be done on the basis of the visual comparison of the column heights. Accordingly, antidepressants (FIG. 2B) that are least likely to cause side effects for this particular patient are duloxetine, trazodone and phenelzine and those that are most likely to cause side effects are fluvoxamine and paroxetine. Each column corresponds to a drug, except for the blue columns indicating the maximum CYP enzyme inhibition.

FIG. 3 is an illustration of the computer output or screen display in connection with an example of the method and system of the present disclosure for visual presentation to a user, and including a graph with a panel of columns whose geometrical characteristics correspond to the assigned numeric values of each indicated drug. The graph visually facilitates the prospective drug selection by a prescriber on the basis of the totality of drug-gene and/or drug-drug interactions presented to the user on the visual graph and reflecting the degree of the interaction on any individual prospective drug that is being considered for prescribing. In the illustrated example, the X-axis lists antipsychotic medications and the Y-axis shows a relative probability of side effects of each drug from 0 to 1. The curved arrow indicates a prospective drug (lurasidone) with the least probability of side effects for the respective patient.

### DETAILED DESCRIPTION OF EMBODIMENTS

The present disclosure is directed to a method of using a computer to conduct pharmacogenetic data analysis and present results of this analysis to an interested party (e.g., a physician, a researcher, dentist or a patient) in a visual graphic format. The method and system of the present disclosure is based on entering the patient's genetic variation, mutation, polymorphism, phenotypic, transcription or other data that are known to affect a biological function, elimination, distribution or binding to a receptor of a drug or a nutraceutical into a computer. In various embodiments of the invention the entry of these data can be done in a number of ways comprising a manual entry, a direct transfer from another computer or a server, reading of a bar code, or any other similar data entry method. In another embodiment, these data are stored locked on a memory chip or transferred from one user to another.

Upon receiving genetic data, the computer processor executes a code that causes the data to search a database of drugs and nutraceuticals whose effectiveness, side effect profile, metabolism or any other biological function may be affected by the mutation or mutations. The degree to which the biological activity of a drug or nutraceutical is affected by the mutation is assigned a numeric value reflecting the nature of the interaction between a drug or nutraceutical and the affected biological function. Information about the nature of the said interaction is derived from peer-reviewed publications indexed in such scientific publication databases as PubMed or Google Scholar, and other reputable databases that index pharmacological information. Examples of such databases could include PharmGKB (https//www.pharmgkb.org, SuperCYP (http://bioinforrmatics.charite.de/supercyp/index.php.World Guide of Pharmacogenomics etc.). The assigned numeric values may be percentage values indicative of either a loss or gain of enzymatic activity (if the gene in question codes for an enzyme) or a change in receptor binding properties (if the gene in question codes for a drug that binds to a receptor). The numeric values may be pre-entered together with the drug database into the computer. In another embodiment, the numeric values may be entered at the time the calculations are being performed, which may be particularly useful for educational and exploratory purposes.

For example, if a mutation that was entered is a partial loss of function mutation in the gene CYP2D6, reducing the metabolizing capacity of the corresponding CYP2D6 enzyme by 25%. By executing a search the computer will assign a 100% value to all drugs that are neither substates, inhibitors nor inducers of this enzyme indicating that the metabolism of these drugs was not reduced by the loss of function mutation in the CYP2D6 gene but it will assign a 75% value to all drugs that may be identified as substrates of this enzyme, indicating slower metabolism of these drugs. Drugs that are identified as inhibitors of CYP2D6 will be assigned a higher value (e.g. 50%) to reflect an additional degree of enzyme function loss. In various embodiments, the assigned values may be the same for an entire chemical class of drugs or they may be assigned to each drug individually.

In a separate embodiment of this invention, further entries of genotype data can be prevented after the initial entry of the genotype data. This may be particularly useful when the user of this method is a patient.

In a preferred embodiment, the numeric values sent by the computer's processor to the output module are converted to a multicolumn graph (or any other geometrical form such as a circle) where each column corresponds to a drug or nutraceutical and the column height corresponds to a degree to which the mutation altered each drug's biological function. Visualization of the drug-genotype interaction allows the user to make a prompt visual comparison between different drugs and select those with minimum interactions between it and the mutated gene product.

In another embodiment of this invention, a correction can be made to reflect the phenomenon of phenoconversion comprising entering a list of drugs that the patient may already be taking and using their assigned numeric values to adjust the effect of the prospective drug on a gene product. This is particularly useful when a patient is already receiving one or more medications and more prescriptions are contemplated.

In another embodiment, a user may be a patient who is taking a medication and is considering adding a nutraceutical compound or an over the counter medication. Some of these medications are substrates of the mutated enzymes competing for enzymatic capacity by defective gene products, while others may be inhibitors that may compromise the defective enzymatic activity even further, especially, if the mutation defect is of an Intermediate metabolizer type. These drugs and nutraceuticals may be entered separately by the user and the user can observe the changes in the plurality of the interactions between the prescription drugs or nutraceuticals and genetic data, and as a result become aware of potential adverse interactions or a loss of effectiveness of his or her current medications.

Since there may be thousands of drugs and nutraceutical compounds, drugs and compounds that are being outputted for visualization by the user may be grouped by their therapeutic area, comprising antidepressants, antipsychotics, antihypertensives, antiepileptics, anti-inflammatories etc.

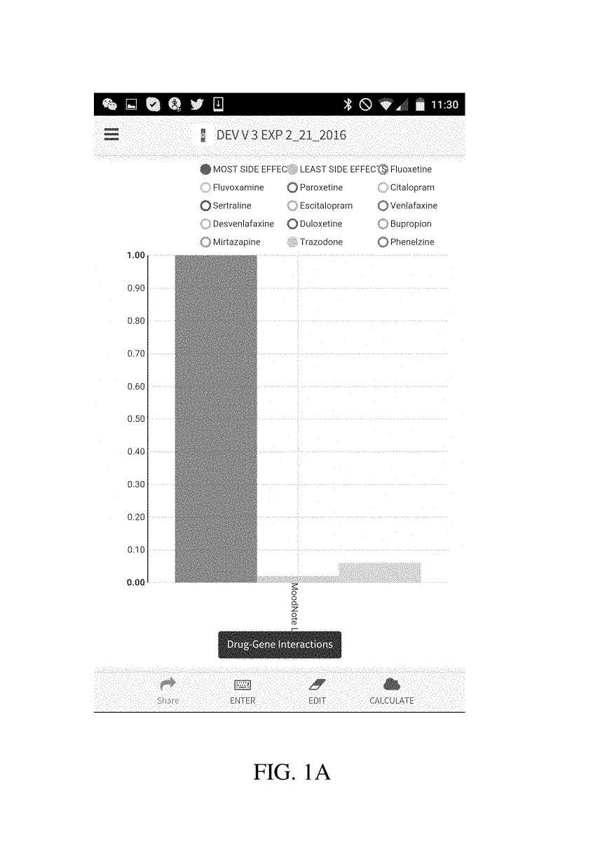

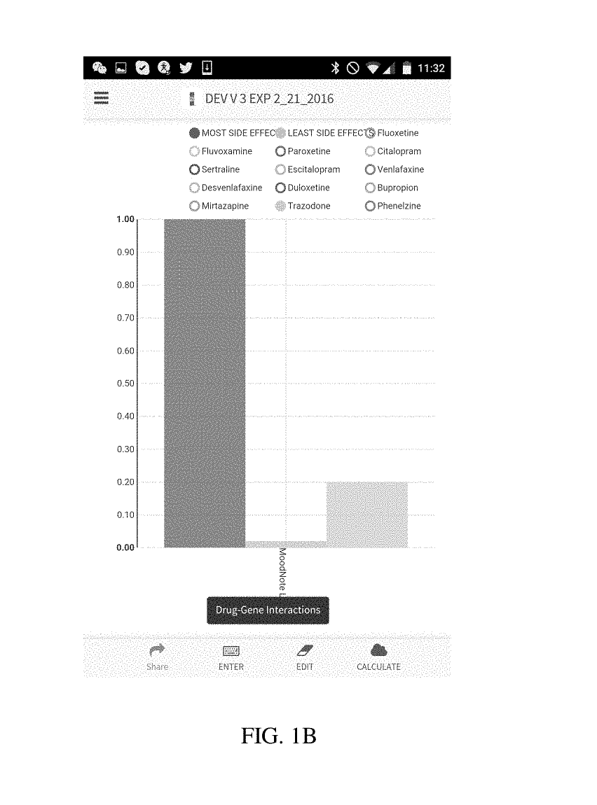

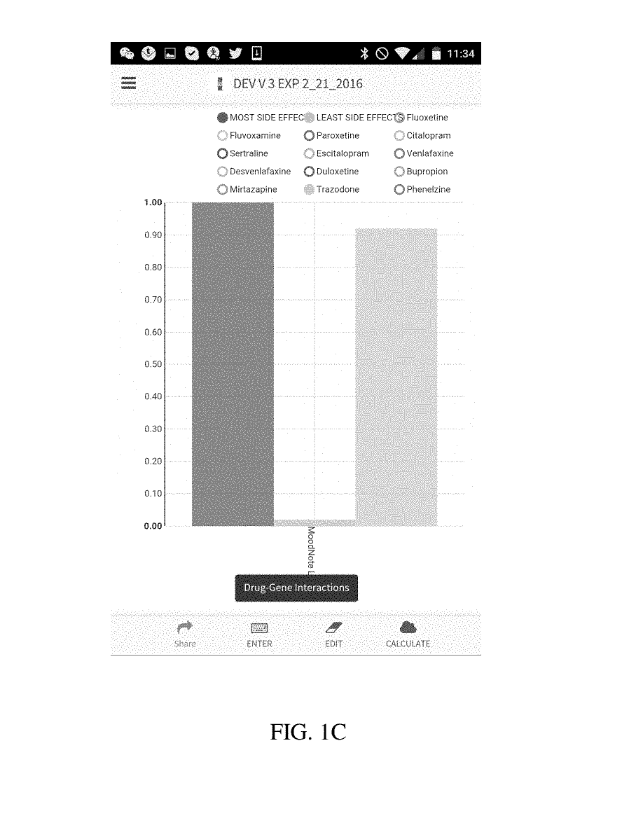

A user of this invention who is a prescriber seeking to prescribe a drug to his or her patient and is looking for a drug that has the fewest side effects (or the greatest effectiveness, etc.) can visually observe the effect of genetic variations, polymorphisms, phenotypes, etc. on a drug or selected group of drugs and make immediate inferences as to the relative magnitude of the mutation's effect on each drug that is being considered for prescribing. This could be illustrated in the following example (FIGS. 1A, 1B and 1C). Elimination of an antidepressant drug “D” from an organism requires a functioning metabolic enzyme CYP3A4. A loss-of-function mutation in the corresponding CYP3A4 gene may result in an inactive or partially active CYP3A4 enzyme, which will slow the metabolism of drug “D” and increase the likelihood of side effects (so-called “Intermediate Metabolizer” gphenotype). If both strands of DNA are affected by the mutation, or if an inhibitor of the CYP3A4 enzyme is added (drug “K”) when the patient is an Intermediate metabolizer, the metabolic function of the CYP3A4 enzyme could be significantly impacted resulting in the phenoconversion to the “Poor Metabolizer” phenotype. In that case metabolism of drug “D” would be much slower than expected in the general population, and the probability of side effects would be much greater compared to only one DNA strand being affected.

In the present embodiment of the invention, the graphic output consists of multicolored columns where the column color corresponds to a specific drug and the column height corresponds to a degree that drug metabolism, side effect, effectiveness, binding to its receptor, or any other biological process involving this drug, is affected by a specific DNA mutation (or mutations) or existing medications.

The term “other biological process” refers to, in addition to drug metabolism by CYP enzymes already described in detail previously, such processes as carcinogenesis, tissue regeneration, inflammation, aging, cardiac conductance (e.g. QTc interval) or other similar processes. A user of this method and system can observe and immediately identify those drugs or supplements whose actions will be most affected or least affected by the presence of specific mutations and/or existing medications. For example, a user can immediately infer from the graph which of the antidepressant medications available for prescribing will have the least and which will have the most side effects in a patient who has a specific DNA mutation.

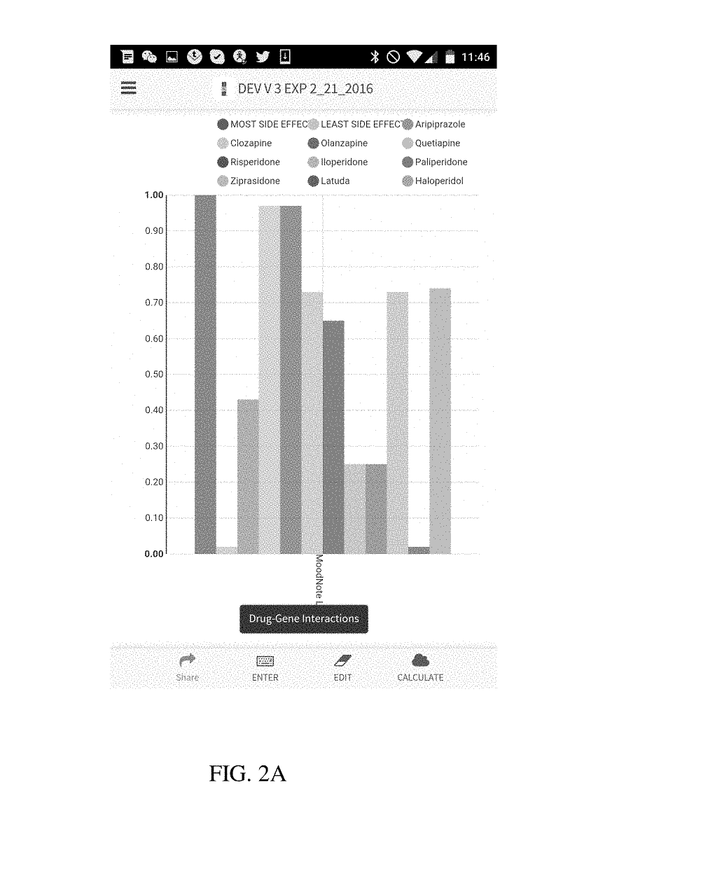

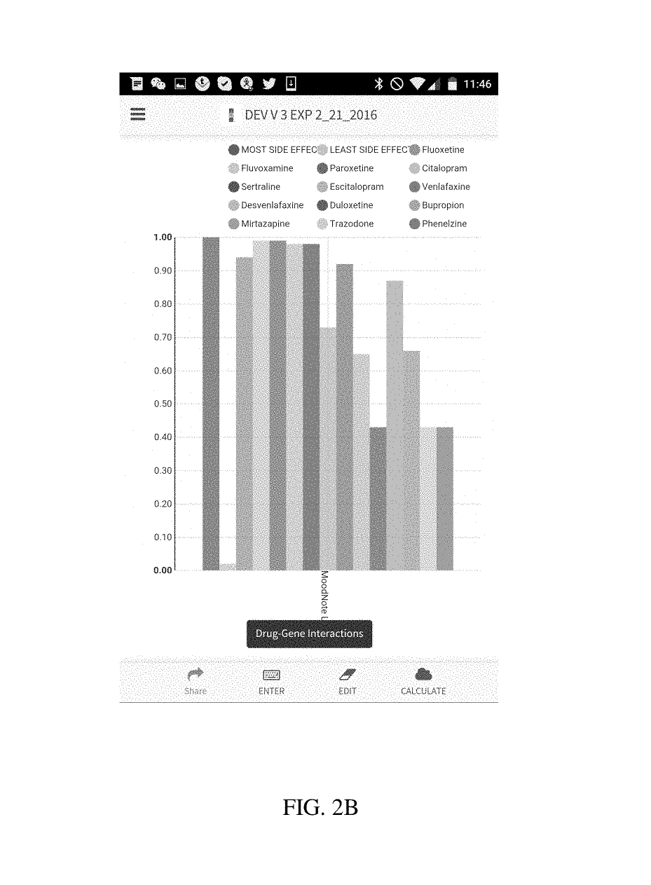

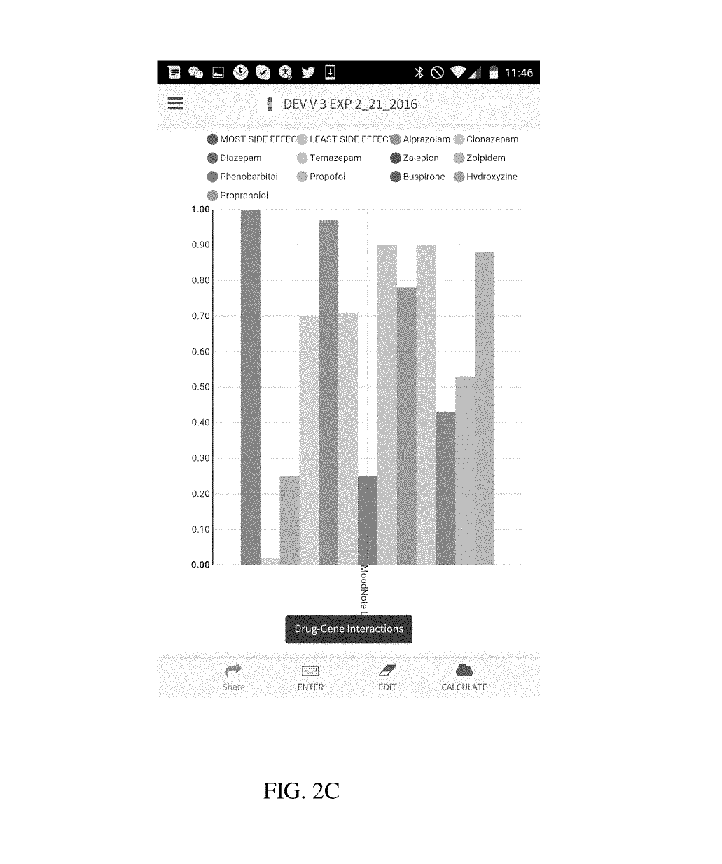

Another embodiment of this invention allows the user to group different classes of drugs and explore DNA mutation and existing medication effects on each class. For example, antidepressant and antipsychotic medications can be selected and viewed separately (FIGS. 2A, 2B and 2C).

In another embodiment, the invention may include an interactive feature that enables the user to further narrow and identify a prescription drug group within a prescription drug class. For example, a user may select within the antidepressant class all drugs that are not SSRIs (Selective Serotonin Reuptake Inhibitors).

In another embodiment, the user may have access to a narrative section where information by drug manufacturers or regulatory agencies pertaining to specific DNA mutations affecting a specific drug dosing may be viewed.

In one embodiment, the patient's genetic data and/or the existing medication can be entered manually, scanned from a barcode or QR code, or submitted electronically through an internet, e.g., Wi-Fi, or another wireless connection. The user is not expected to perform any laboratory experiments or obtain any data other than the data that was made available to the user. Duplicate entries or incorrect combinations of genetic data are blocked programmatically. Data processing may take place on a central server or locally on the user's mobile device or computer. If there are several users sharing one device that employs this tool, users may be required to log in in order to have calculation results available only to a specific user. In none of the embodiments, patient's personally identifiable information (e.g. name, address, date of birth) is required for the calculation and visual output, and such information is not being collected at any steps of the operation.

This invention in its various embodiments may be used by a qualified health care practitioner including an MD, DO, NP, ND, a dentist, a physician assistant or other practitioner that is a qualified prescriber of a medication or medications, or a nutritional supplement to a patient or another healthcare consumer, male or female (including a research study subject, in whole or in part, regardless of whether the subject is a human or an animal), whose DNA sequence, or presence of specific RNA transcripts, or proteins associated with a specific DNA sequence or RNA transcripts that are known to interact with medications or nutritional supplements, have been revealed, in whole or in part, to the said prescriber in order to minimize side effects and enhance effectiveness of a medication or nutritional supplement that is being prescribed or recommended.

In another embodiment, the invention may be used by a healthcare consumer or said consumer's next of kin to calculate the interaction effects of over the counter medications on prescription medications and nutraceuticals, including medications and nutraceuticals that the healthcare consumer is currently taking or considering taking in the future regardless of whether the genetic information is known or unknown to the consumer.

In another embodiment, this invention may be used by a health care provider or consumer who was informed of the consumer's genetic information comprising genetic mutations, polymorphisms, DNA methylation or other mechanisms of deregulation of gene expression contributing to a pathological state of a tissue or an organ, with an intent to select medications or nutritional compounds that have the opposite effect on the deregulated genes.

In its various embodiments, this invention can be installed and run as a smartphone, tablet or computer application (i.e. an “App”). In other embodiments, it can be run in a web browser on a smartphone, a tablet or a computer that is connected to the internet and can be forwarded from one user to another by sending an URL address or a QR code. It is not necessary for the user be skilled in the art of computer technology, programming or genetics in order to use this invention. Any physician, dentist, nurse practitioner or other qualified health care provider who prescribes medications or recommend nutritional supplements to his or her patients or clients, can use this invention. Students of biomedical or health sciences including research scientists, as well as health care consumers can use this invention, in order to, for example, improve their understanding of interactions between a drug and a biological substrate.

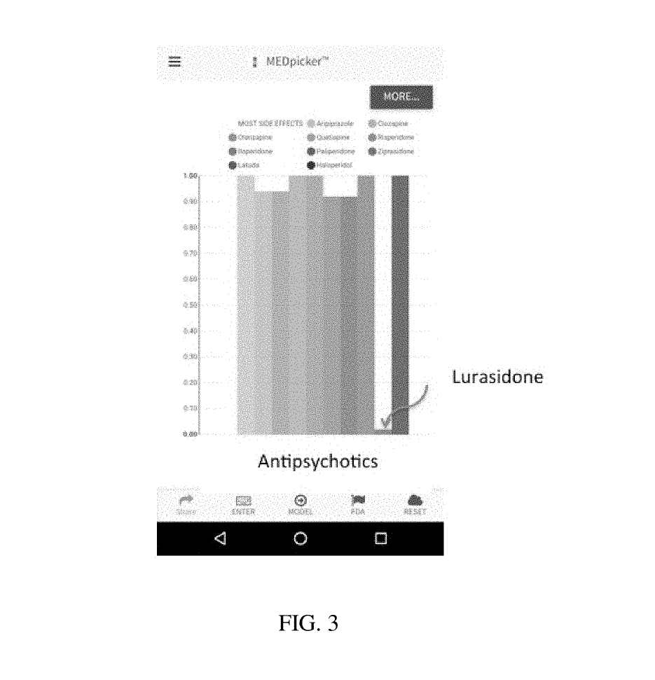

FIG. 3 presents an example of an application of the method and system to a 46 year old man exhibiting psychosis and intolerance of antipsychotic medications due to side effects. Briefly, the patient's symptoms started at age 19 and continued until the present day. He felt that someone was behind his back and he could communicate using mental telepathy. He was diagnosed with depression, schizophrenia and bipolar disorder by several practitioners and treated with depakote, prozac, cogentin, zyprexa, abilify, haldol, Benadryl, Lexapro and risperidone, but could not tolerate any of these medications due to side effects (e.g., he would become violent if taking fluoxetine).

Pharmacogenomics testing was done and revealed the following genotypes and corresponding phenotypes: CYP2B6 *1/*6 (intermediate metabolizer), CYP2C19 *1/*17 (ultrarapid metabolizer), CYP2D6 *4/*4 (poor metabolizer), CYP3A5 *3/*3 (poor metabolizer), CYP2C9, CYP3A4 both *1/*1 (normal or extensive metabolizer).

Entering this data into the computer (in the present embodiment the computer was a smartphone) and performing calculations of metabolic rates as described above, a resulting chart showed that of all antipsychotics, lurasidone (Latuda) would have the fastest metabolism and cause least side effects (curved arrow pointing to the lowest column), while other antipsychotics would likely cause significant side effects. The patient immediately started treatment with lurasidone at a dose of 40 mg a day and after 4 weeks of treatment his psychotic symptoms subsided without any significant side effects. The X-axis lists antipsychotic medications, the Y-axis shows a relative probability of side effects of each drug from 0 to 1. The curved arrow indicates a prospective drug (lurasidone) with the least probability of side effects.

The terms “tool”, “application”, “app” , “computer” as they are used here refer to executable code that anyone skilled in the art of computer or smartphone programming could compile. Terms “genetic test”, “genetic test results”, “DNA sequence variations”, “single nucleotide polymorphisms”, “SNPs”, “alleles”, “mutant alleles”, “mutations”, “mutants”, “variations”, “genetic data”, “genotype” etc., as they are used here, whether in singular or plural, refer to DNA or RNA code variations of any type that may become known to the user of this invention without performing an analysis of a DNA sample, or RNA sample or a tissue sample. The term “compounds”, “drugs”, “medications”, “nutrients”, “nutraceuticals”, “supplements”, “vitamins” etc. as they are used here refer to prescription or over the counter medications, drugs, supplements, nutrients, foods and their biologically active constituents. The term “existing medication” refers to a drug or supplement that the patient may already be taking. The term “prospective medication”, “prospective drug” refers to a drug or a supplement that is being considered to be prescribed or recommended.

As may be recognized by those or ordinary skill in the pertinent art based on the teachings herein, numerous changes and modifications may be made to the above-described and other embodiments of the present invention without departing from its scope as defined, for example, in the appended claims. Accordingly, this detailed description is to be taken in an illustrative as opposed to a limiting sense.

What is claimed is:

1. A method of visualization and pictorial presentation to a user of possible interactions between a prospective drug that is being considered for prescribing to a person and that person's genotype, comprising:
entering the person's genetic information into a computing device, wherein the entered genetic information may be a person's genetic data reflecting distinct pharmacogenetic phenotypes of cytochrome oxydase P450 (CYP) genes coding for the corresponding CYP enzymes and termed as poor, intermediate, extensive, and ultrarapid metabolizers, DNA variation data that may include single nucleotide polymorphisms (SNPs), copy number variations (CNVs), insertions/deletions (indels) or other variations appearing anywhere in the patient's DNA, DNA methylation, acetylation or any other data of up- or down-regulation of gene expression that affects the manner in which a drug acts on any molecular, physiological or biological function of the body or a tissue, or a manner in which a drug is being metabolized, absorbed, excreted or otherwise eliminated from the body or a tissue by the body or tissue systems, and
whereupon the data entry causing (i) a computer to conduct a search of a drug database for drugs that have known interactions with the entered genetic information, and assign a numeric value to each of a plurality of drugs, either in aggregate, as a class, or individually, in order to quantify the nature, strength and direction of each interaction, (ii) causing the computer's processor to send the assigned numeric values to the computer's output module for their visual presentation to a user as a graph including a panel of columns, or other geometrical structures, whose geometrical characteristics corresponds to the assigned numeric values of each drug, and which can be subsequently further adjusted according to the numeric values assigned to a separately entered list of drugs that represents drugs that the patient is currently taking, which are also known to interact with the patient's genotype, in order to facilitate the prospective drug selection by a prescriber on the basis of the totality of drug-gene and drug-drug interactions presented to the user as a visual graph, reflecting the degree of the interaction on any individual prospective drug that is being considered for prescribing.

2. A method as defined in claim 1, further comprising receiving in a computerized device a list of drugs and observing effects of such drugs on genotype-dependent changes in drug biological functions.

3. A method as defined in claim 2, wherein the list of drugs includes a drug that the person is currently taking or is considering taking in the future.

4. A method as defined in claim 2, where such functions include inflammation, carcinogenesis, electric conductance, aging, neurodegeneration, growth, tissue differentiation, secretion, reproduction.

5. A method as defined in claim 4, wherein the electric conductance includes cardiac electric conductance.

6. A method as defined in claim 5, wherein the cardiac electric conductance includes the QT interval and variations thereof.

7. A method as defined in claim 1, further comprising receiving in a computerized device genetic data where such data are RNA-seq data.

8. A method as defined in claim 1, further comprising receiving in a computerized device genetic data where such data are methylome data.

9. A method as defined in claim 1, further comprising receiving in a computerized device genetic data where such data are proteomics data.

10. A method as defined in claim 1, further comprising receiving in a computerized device genetic data where such data are transcription data.

11. A method as defined in claim 1, further comprising receiving in a computerized device genetic data where such data are derived from human studies.

12. A method as defined in claim 1, further comprising receiving in a computerized device genetic data where such data are derived from non-human studies.

13. A method as defined in claim 1, wherein the computer performing calculations and data presentation is a tablet, a smart phone, a laptop, a desktop or other computing device that has graphic output capabilities.

14. A method as defined in claim 1, wherein the user may be also a patient whose genetic and drug interaction data are being analyzed and visually represented.

15. A method as defined in claim 1, wherein the method further comprises receiving, in a computerized device a list of drugs that could include any drug that the person may be currently taking or may be considering taking in the future and observing effects of a plurality of such drugs on the graphical depiction of the drug-genotype interactions and subsequently varying and re-entering the prospective drug candidates in order to obtain a most desirable level of drug interactions as is reflected in the drug-genotype interactions graph.
